(19) United States
(12) Patent Application Publication
(10) Pub. No.: US 2012/0029656 A1
(43) Pub. Date: Feb. 2, 2012

(54) METHOD FOR DEVELOPING A MULTI-AGENT SYSTEM AND MULTI-AGENT SYSTEM

(75) Inventors: Armando Walter Colombo, Karlstein (DE); Joao Marco Mendes, Ponte de Lima (PT); Paulo Leitao, Braganca (PT)

(73) Assignee: SCHNEIDER ELECTRIC AUTOMATION GMBH, Seligenstadt (DE)

(21) Appl. No.: 13/123,762

(22) PCT Filed: Oct. 13, 2009
(86) PCT No.: PCT/EP2009/063366

§ 371 Date: Sep. 19, 2011

(30) Foreign Application Priority Data
Oct. 13, 2008 (DE) 10 2008 037 446.6

(51) Int. Cl. G05B 15/02

(52) U.S. Cl. 700/7

(57) ABSTRACT

A method for developing a multi-agent system and a multi-agent system, such as an automation and/or production system, including software and/or hardware components, the resources and functions of these components being represented and/or controlled through software agents, each of the software agents having the capability of achieving goals through interaction with the environment and with other agents. In order to increase reconfigurability and flexibility, the resources and functions of the software agents are depicted as services, where each software agent, in order to achieve its own goals, calls up services of other software agents and offers its own resources and functions to other software agents as services.

The invention relates to a method for the development of a multi-agent system according to the preamble of claim 1 as well as a to a multi-agent system according to the preamble of claim 2.

In a publication by Professor Dr. Peter Göhner: “Agentensysteme in der Automatisierung” [Agent systems in automation]; University Stuttgart, 2005, IAS, the construction of different automation systems is described. Among other systems, agent-oriented automation systems are described, where agents fulfill automation functions. Agent-oriented automation systems are characterized by a flexible subdivision of functions as well as free action relations between agents. Furthermore, an exchange of functional and behavioral information occurs via abstract interactions. The type of interaction is not explained further in this paper.

As agent, a software unit with defined goal is defined, with autonomous behavior to reach the goal, and with the capability of interaction with an environment and other agents. In particular, an agent contains an image of the relevant environment, defined goals as well as capabilities.

Regarding the implementation of agents, it is indicated that different possibilities are available, such as, for example, agent-oriented programming languages, such as, AGENT-O, conventional programming languages as well as agent frameworks/platforms, such as, for example, JADE or LS/TS.

Regarding agent frameworks and platforms, it is indicated that they are usually implemented in conventional programming languages, such as, JAVA. The agent frameworks and platforms offer aids for agent generation, life cycle managements and persistence, libraries for different behavior strategies, platforms for agent communication, such as, for example, languages, such as, ACL, protocols as well as aids for agent interaction, such as, for example, directory services (Yellow Pages).

Methods for programming a multi-agent system are also described, for example, in EP 1 577 724 A2 and EP 1 659 468 A2.

However, the above-mentioned development processes are bound to a certain technology, so that, once developed, a software agent can be used only in certain frameworks/platforms.

Furthermore, the invention relates to the field of distributed intelligent systems, covering a significant area of application fields, for example, telecommunication, industrial automation, manufacturing systems, and optionally the vertical IT enterprise integration, from the strategic business levels to the apparatus level. The invention addresses the need for the development of flexible and intelligent systems which support the requirements for modularity, reconfigurability, reusability, distribution, and heterogeneity.

In an article by F. Jammes; A. Mensch; H. Smit: “Service-oriented device communications using the device profile for Web Services,” MPAC '05, Nov. 28-Dec. 2, 2005, Grenoble, France, the advantages of introducing service-oriented architectures at the level of the communication between a resource-dependent embedded apparatuses are described. In particular, the use of so-called “Device Profiles for Web Services” (DPWS) as basis for such architectures for “intelligent” apparatuses is discussed.

“Service-oriented architecture” (SOA) is defined in the article—as well as below—as an architecture as set of architectonic principles for the construction of autonomous and dialog-capable or completely compatible systems. Here, “autonomous systems” are defined as systems that are formed independently of each other, operated independently of their environment, and present an inherent functionality; for example, this functionality can be helpful even if it is not coupled with a functionality of higher level.

The dialog capability or complete compatibility is favored by clear abstraction of the interfaces or of the communication interfaces, which a service presents to its environment by the implementation of the service.

A fundamental interaction pattern of an apparatus level SOA can be described using five function levels: addressing, discovering, describing, control, and event. Here apparatuses are characterized either as controlling or controlled apparatuses, where, however, a given apparatus can embody both roles, and allows “peer-to-peer” interactions. Furthermore, apparatus level service-oriented protocols are described, such as, for example, UPnP (Universal Plug and Play) including IP, TCP, UDP, HTTP, SOAP and XML.

The approach via “Device Profile for Web Services (DPWS)” is also described in detail, presenting the same advantages as UPnP, but in addition oriented completely to Web Service Technologies.

The DPWS specifications define an architecture in which apparatuses present two types of services: “hosting services” and “hosted services.” “Hosting services” play an essential role in the discovery process of the apparatus. “Hosted services” are usually functionally dependent on their “hosting” apparatus for discovering. In addition to the “hosted services,” DPWS specifies a set of integrated services:
“Discovery Services:” They are used by an apparatus which is connected to a network, to let themselves be known and to discover other apparatuses.
“Meta Data Exchange Services:” They provide dynamic access to a “hosted service” of the apparatus and to its metadata, such as, for example, WSDL or XML schema definitions.
“Published Subscribe Eventing Services:” They allow apparatuses to subscribe to asynchronous event messages, which are produced or generated by a given service.

In DPWS language usage, a “controlled” apparatus is referred to simply as “apparatus,” while a “controlling” apparatus is referred to as “client.”

A DPWS protocol stack has the following structure:
“WSDL” (Web Services Description Language) for the abstract description of service communication interfaces (interfaces) and their connection to transmission/transport protocols
“XML Schema” for the definition of the data formats which are used for constructing the messages that are addressed to services and received by services
“SOAP,” the protocol for the transport of service-related messages which are formatted in agreement with the corresponding WSDL definitions
“WS Addressing” is closely connected with the SOAP, and it concentrates all addressing information in the header of the SOAP message envelope, which makes it possible for the message content to be transmitted via any transport protocol (HTTP, SMTP, TCP, UDP, . . . )
“WS Policy” is used to express rules in connection with the Web Service, in the form of “Policy Assertions,” which complete the WSDL description of the service
“WS Metadata Exchange” allows the dynamic querying of metadata, which are associated with a Web Service (description, schema and policy), and thus makes available a Web Service self verification mechanism
“WS Security” is an optional set of mechanisms for the safeguarding of “end-to-end” message integrity, confidentiality, and authenticity.

The DPWS protocol stack integrates all the above presented standards. In addition to the above described Web Service kernel protocols, DPWS completes Web Service protocols for “Discovery” and “Preventing.” For example
“WS-Discovery” is a protocol for “plug-and-play” discovering of network-linked resources. It defines a multicast protocol for searching and discovering of apparatuses. Once found, the apparatus shows the services which it makes available.
“WS-Eventing” defines a “publish-subscribe” event processing protocol, which allows a Web Service to exchange event-related messages with other Web Services. WS-Eventing is provided for the implementation of a series of applications, from apparatus-oriented to “Enterprise-scaled-published-subscribed” systems, in the upper part of the same substrate.

Typically, each DPWS-based service has a WSDL description. This description is apparatus-specific; thus, different apparatus types have different WSDL descriptions with few features in common.

The code of the DPWS-Service is, in various functions, required to process messages. These functions depend on the DPWS description of a certain service. In this connection, to allow a service to be able to communicate with another service, both services have to implement the given specific functions of the other service. Therefore, each WDSL description, must be compiled every time a new service has been formed, to generate a Server Code and Client Code.

If the services that abstract the apparatuses communicate with each other in a dynamic environment with a large number of apparatuses, then, for a certain service, based on the messages which it exchange with others, it becomes impractical to implement all the users. This is particularly critical if the apparatus is exposed to a large number of processes/courses.

Moreover, in network environments, in which an aggregation of apparatuses is desired, reprogramming can be a serious impediment of dynamic accumulation and immediate operationally ready connectivity of the system.

In this connection, reference is also made to the publications WO 2008/09021 A2 as well as WO 2008/101912 A1, whose disclosure is here included with its full content.

Based on the above, the fundamental problem of the present invention is to further develop a method for the development of a multi-agent system as well as a multi-agent system, in such way that software agents can be used independently of technology, which improves the modularity, reconfigurability, and interoperability in heterogeneous environments.

The problem is solved according to the invention by a method with the characteristics of claim 1 as well as by a service-oriented multi-agent system with the characteristics of claim 2.

Multi-agent systems (MAS) and service-oriented architectures (SoA) specify two paradigms which are transferred to and developed in the field of industrial automation and production. Both offer their own advantages and are based on separate models; however, they also have common background requirements, characteristics, and applications.

The present idea specifies a technology-independent method for the development of multi-agent systems, which is guided by service orientation, and used to manage and to solve heterogeneous and simultaneously occurring automation and production plans and problems.

The idea represents a new approach to develop modular, pluggable, flexible and reconfigurable systems, particularly for industrial automation and manufacturing systems, based on the concept of multi-agent systems (MAS) and service-oriented architectures (SoA).

The approach is characterized by the use of a set of distributed autonomous and cooperative units, the agents, using SoA principles, which allow an increased modularity, reconfigurability, and interoperability in heterogeneous environments.

The development of such service-oriented multi-agent systems (SoMAS), which present differences with respect to conventional multi-agent systems, requires a development environment which supports the new functionalities.

The idea describes particularly a method for the development of a multi-agent system which is oriented with respect to the offer and the query of services, to achieve industry and production goals. The approach differs from the conventional multi-agent systems in that:
Agents are service-oriented: individual goals of agents can be supplemented by other readied services. Internal properties of agents can be offered as services to be queried by others
Characteristics are taken over by service orientation: A main characteristic is the reusability of services of an agent, which can be used and applied not only for a single problem type, for which it was developed, but which is also reusable for different applications.

The idea represents a reference model in which the communication and the development technology is open. This means that any appropriate technology for the development of the concept presented by the reference model can be used. For example, Web Service technologies can be adapted to the resource access via services, and C++ or Java languages can be used for the development of the agents.

The approach described in this invention uses characteristics of MAS (Multi-Agent Systems) and SoA paradigms, combines them to construct distributed, intelligent systems which react better to the current requirements, specifically with regard to modularity, flexibility, reconfigurability, and adaptability. The concept of such a system will be an example for the field of manufacturing systems.

The idea is formulated in a reference model which provides the general foundations, in order to specify a service-oriented multi-agent system for solving problems and achieving goals in industrial automations and productions.

The purpose of the patent proposal is to provide a new approach for the development of distributed, intelligent systems, which present modularity, flexibility, reconfigurability, and interoperability functions, combined with the best characteristics of MAS and SoA paradigms.

The following themes summarize the fundamental advantages of the idea:
Combination of the best characteristics from MAS and SoA paradigms broaden the capacity of autonomy, modularity, flexibility and interoperability, and consistent reconfiguration which is needed in distributed control systems.
Paradigm which guarantees 100% distribution and “heterarchical” (meaning: hierarchical and distributed) control approach.
The use of service-oriented principles simplifies the vertical enterprise integration.
Transparency, because the agents can be developed using different methods and technologies, because interaction patterns are defined, and are a common standard.
Integration in information technology and business level (usually operation in a service-oriented manner).
Enlarged capabilities for decentralization.

Additional details, advantages and characteristics can be obtained not only from the claims, the characteristics taken from them—separately and/or in combination—but also from the following description of preferred embodiments to be taken from the drawing.

The figures show:

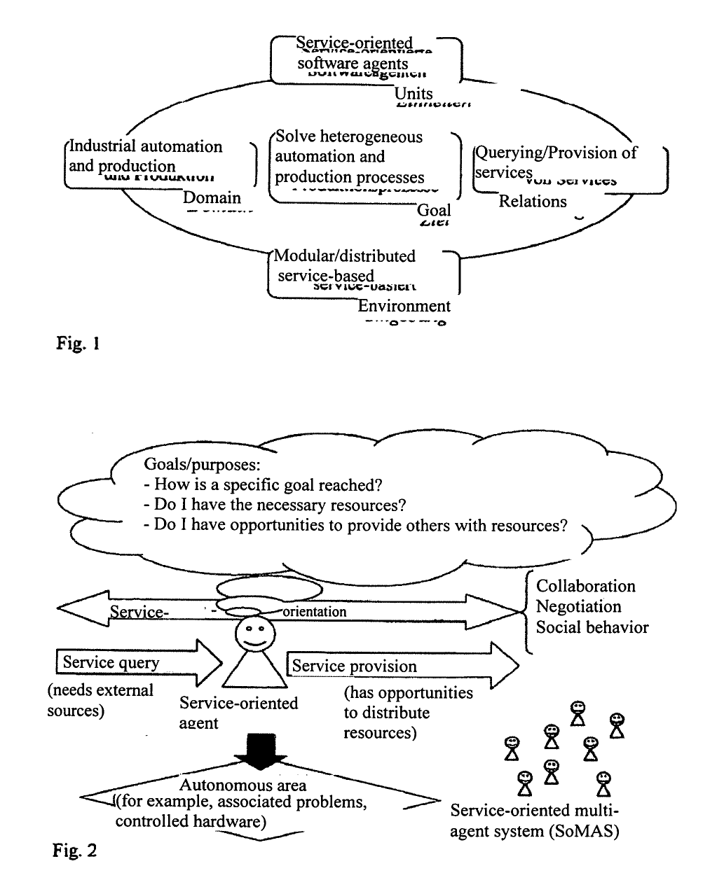

FIG. 1 a model based on different key concepts,

FIG. 2 a diagrammatic overview of a service-oriented multi-agent system with service-oriented agents,

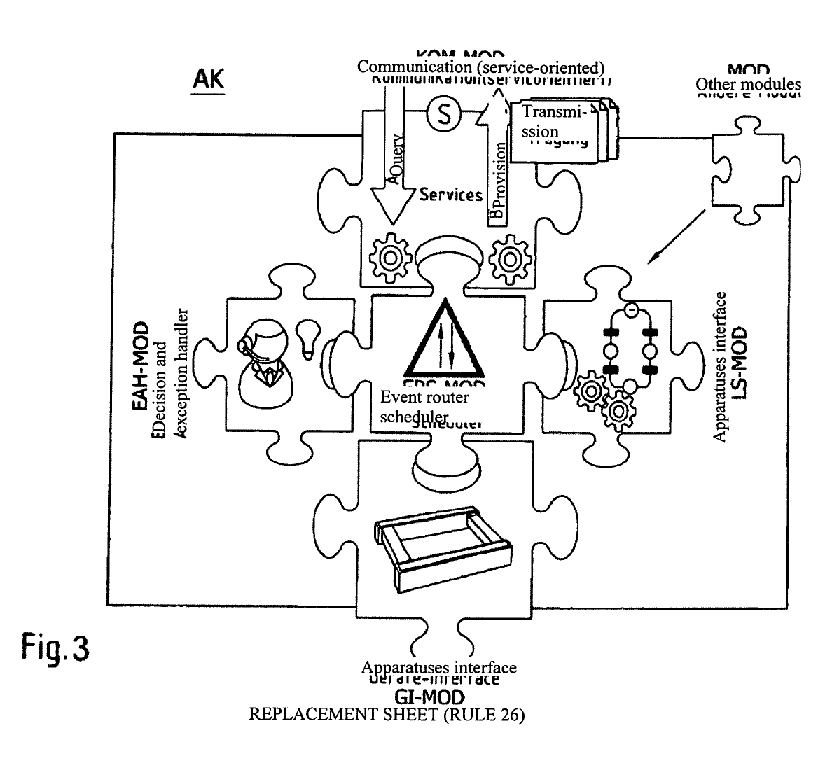

FIG. 3 modular structure of an automation component, and

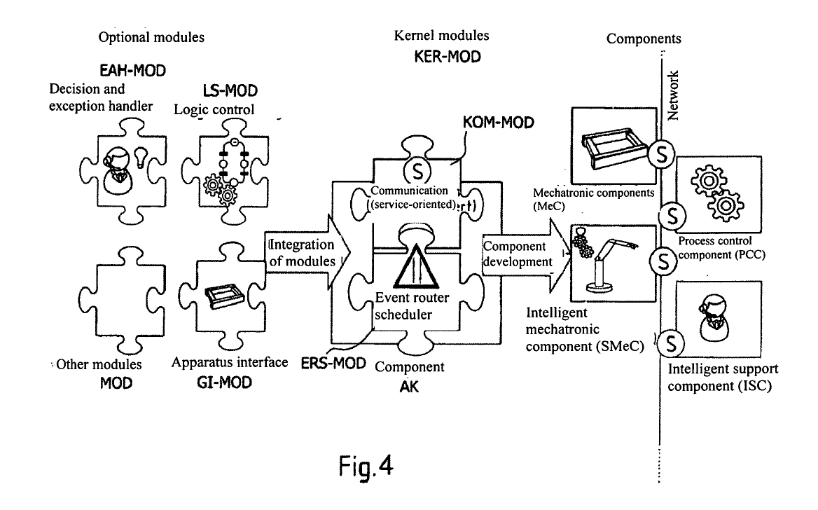

FIG. 4 configuration of modules for the formation of types of automation components.

A model which is the basis of the invention is represented in FIG. 1, which is explained below:
Task field (Domain): Industrial automation and production: The task field of the reference model is applied to the field of industrial automation and production consisting of software and hardware components.
Goal: To solve heterogeneous automation and production processes: Because modern and flexible systems comprise heterogeneous and simultaneously occurring activities, and include them, the model is intended to apply to the management and the solution of processes for the automation of apparatuses and also the production of goods. Processes can comprise simple static descriptions of work plans for the achievement of a given goal or dynamically constructed collaborations for a more flexible approach.
Environment: Modular/distributed, service-based: Software and hardware components are contained in the system. Software components are generally agents with specified functions (tasks) and they can also represent/control hardware components. Resources and functions of agents and other software components are represented as services.
Details: Service-oriented software agents: A software agent is a unit which acts for a user or an apparatus, and has the capability of solving its own goals. Several additional concepts include the degree of autonomy of agents, and also their learning and intelligence capability. A multi-agent system is used if complex goal definitions are elaborated from separate individual problems which can be solved by individual agents, and their collaboration, reduction of the complexity of the overall problem.

The introduced enlargement requires a service-oriented approach to the agents. In this case, the agents are guided by their own needs and motivation for the solution of their problems; however, they can also supplement their needs by calling services made available by other agents, and they also have the capacity of making available services to the community.

FIG. 2 shows a schematic overview of service-oriented agents and service-oriented multi-agent systems.

A particular characteristic made available by the approach is that each agent can be internally independent and implemented differently (for example, by using a different technology, for example, different decision techniques, different logic controllers, etc.). The only requirement is that it must distribute its functions as services, and follow the communication protocols and performed processes. This flexibility can make a contribution in the development of client-specific components for diverse tasks. A suggestion for the internal specification of these service-oriented agents is the adoption of a modular approach, as described in the Patent Application “Modular and functional structure for service-oriented automation components” (DE 10 2008 002 827.4).
Relations: Queuing/Provision of services: Problems and sub-problems are solved by agents which should collaborate. The collaboration is achieved by the provision of services by agents (if they have the characteristics) and by querying them (if agents have needs).

Several other themes relate to the development of systems which are specified and developed according to the reference model. On the other hand, and since the reference model is technology-independent, the development of consistent service-oriented multi-agent systems can be carried out using currently available agent development frameworks and service-oriented systems. The following must be taken into consideration, not as part of the model, but as important aspects of the development.
Description of knowledge and semantics: Agents are able to understand what the information associated with services and other elements is.
Centralization/decentralization of units (agents) and tasks. Due to the flexibility of the reference model, implemented systems can adapt a centralized approach (for example, master/slave agents) or a completely decentralized distribution (more collaborative activities between agents, exchange of their services);
Description of processes which describe the behavior of agents and the use of services can be used as supplementation for coordination of activities.
Services can be aggregated/associated, simplification of the external access to resources.
A path for addressing and recognizing services and agents.
Autonomy and proactivity of agents should be taken into account, not only in the sense of the provision of services, but also the capability of querying them, and having decision and control “autonomy” over a part of the problem.

Several examples and applications can be indicated, which are based on the reference model. A conventional manufacturing scenario comprises several system components which can be characterized: production/transformation machines, transport system, storage/warehouse, and the product itself. If one considers a multi-agent system which is used for such a scenario, software agents would represent the different elements in the system and act via the latter. For example, an agent exists for each specific production machine, each transport module, and each set of products. An agent responsible for a production machine has the necessary properties to offer production services (for example, filling of the can), so that it can offer this type of service. However, beforehand, its needs must have been met: obtention of a specific fluid from a source, which had been negotiated (and requested) from another agent that makes available such a service. An agent that handles several products is provided proactively in the sense of the requesting of transport services (from the transport system) to be able to transfer products between different localities, and possibly request production services which are provided by production machines to agents. This is achieved by following an operational course of services, which was established for a production type.

A generic architecture for service-oriented automation components AK defines that an automation component is structured in a puzzle of pluggable and reusable modules ERS-MOD, KOM-MOD, GI-MOD, LS-MOD, EAH-MOD, as represented in FIG. 3, where each has its own function. The main modules that are considered here are: logic control LS-MOD, communication KOM-MOD, decision and exception handler EAH-MOD, apparatus interface GI-MOD, and event router schedulers ERS-MOD.

The logic control module LS-MOD, which can also be referred to as orchestration module, regulates the behavior of the automation components by coordination in the sense of composition and orchestration of a set of services S according to its behavior, described by logic model. The logic embedded in the automation components is dependent on the system topology; however, the latter should be independent of the process plan of each product. A possible approach for the development of logic controller (for example, design, validation, simulation, and execution) can be used for service-oriented system-adapted high-level Petri nets, where the advantages of their high-performance mathematical foundation to represent discrete, dynamic and distributed systems are used. These logic controllers (orchestration machines) must interpret and carry out the process model expressed in Petri nets.

The presence of logic control modules LS-MOD in more than one automation component allows the construction of a non-hierarchical architecture, which means that the supervising control is actually distributed, and not centrally coordinated. In this case, the processes encapsulated by the coordination of Services S must interact with each other in order to achieve the same synchronization level as would be made available by a centralized unit.

The communication between the automation components AK is carried out by the integration of Services S of the automation components, which are contained in the communication modules KOM-MOD, and made available by them. For example, a conveyor belt can make available the transfer service, in order to handle the movement of pallets, and it can be used by other automation components; however, it can also query external services S, if they are needed (for example, to be connected to another conveyor, the request for the transfer service of another conveyor is needed). A suitable technological solution to implement the service-oriented communication modules KOM-MOD is the use of Web technology, and particularly Web Services.

The decision and exception handler module EAH-MOD makes available in real time decision finding and conflict solution services, to support the coordination of the performance of the services S, because the logic model of the system does not describe a fixed sequence of actions, allowing instead all possible combinations of actions. For example, if a system is flexible due to redundancy of service providers, the concrete mapping of services to apparatuses must be decided in real time. The degree of complexity which is connected with the decision finding mechanism, can range from simple algorithms to complex calculated systems, such as, for example, multi-agent systems, expert systems, neuronal networks, and genetic algorithms.

The apparatus interface module GI-MOD makes available the mechanisms for the integration of the physical apparatus, such as, for example, robots or sensors, inside the control part of the automation component. Because local apparatus controllers usually present closed architectures, it is necessary to develop envelopes to hide the details of each apparatus controller and make available primitive functions which represent the functionality of the physical apparatus. The apparatus interface module GI-MOD has the purpose of meeting these tasks by making available mechanisms to support the simple and transparent integration of physical apparatus within the control applications.

The heart of the structure is the Event Router Scheduler Module ERS-MOD, which acts as a coordinator for the various asynchronous and competing component modules.

An important characteristic, which is represented by the proposed generic component structure, is that each automation component of the architecture can be implemented independently and differently. The only requirement is that the automation component should share its functions as services with others, and follow the communication protocols and processes. This flexibility can contribute to the development of client-specific components for diversified applications.

The generic modular structure for the service-oriented automation components can be used to implement different types of automation components, which participate in the control, namely the Mechatronic components MeC, process control components PCC, and intelligent support components ISC, as represented in FIG. 4. The development of automation components AK is achieved by establishing sets of kernel modules KER-MOD, such as, for example, a communication module KOM-MOD and Event Router Scheduler Module ERS-MOD, which are made available by the generic structure, and by selection of optional modules, such as, for example, logic control module LS-MOD, apparatus interface module GI-MOD, and decision and exception handler module EAH-MOD, corresponding to the type and function of the automation components MeC, SMec, PCC or ISC, as represented in FIG. 2.

The component MeC comprises the mechanical, electronic and software combination, which allows the local control of the physical apparatus. Besides the communication KOM-MOD and Event Router Scheduler modules ERS-MOD, which are the kernel modules, the logic control module LS-MOD can also be embedded, to regulate its local behavior in cases where the decomposition of nuclear operations is possible, and the apparatus interface module GI-MOD then synchronizes the services, which are made available by the physical apparatus, such as, for example, read inputs, write outputs, or calling of programs.

The component MeC can also present its own intelligence embedded. In this case, the component is referred to as intelligent mechatronic component SMeC. The component SMeC can also represent composite automation components, in the sense that an automation component is an aggregation of several other automation components, such as, for example, a transport system which is constructed from individual conveyance units. Besides the modules inherited from the components MeC, the structure of this type of automation components also contains the decision and exception handler module EAH-MOD, which makes available local decision support for the logic control mechanism, in the case where a decision needs to be made or a conflict solved.

Other application examples of the generic structure for service-oriented automation components AK are the development of process control components PCC. In more complex systems, which are constructed from small mechatronic automation components, it is necessary to have automation components which make available the global process coordination mechanisms.

The components PCC, which present their own logic control, provide this type of mechanisms, and act as clients that are capable of using services made available by other automation components. The component PCC supports the complex process flow and the interaction of services in the system, in accordance with the process model. For this application, they implement the logic for the work flow-oriented performance and sequencing of nuclear services, and they make available a high level interface for the aggregated process which is composed of individual partial processes. For example, a robot can make available a transport service which contains various operations, such as, for example, gripping, moving and positioning. The robot can synchronize its activities with its connected neighbors, and, if necessary, receive commands from global components. The structure of this type of automation components comprises the communication module KOM-MOD, Event Router Scheduler Module ERS-MOD, logic control module LS-MOD and the decision and exception handler module EAH-MOD. Because these types of components do not require recourse to physical hardware, the apparatus interface module GI-MOD is not contained in this structure.

As a result of the idea, a common and generic structure for service-oriented automation components will be made available, which supports the simple and rapid development of flexible and reconfigurable production systems.

The following themes summarize the actual advantages of the application of the idea:
Definition of a common structure for service-oriented automation components which simplify the development of reconfigurable systems and the vertical enterprise integration;
Functional separation of modules which can be used again for different applications. The modules can be developed independently, because they have implemented the necessary interfaces for intermodule communication;
Integration transparency, because the module structures can be developed using different methodologies and technologies;
System integration transparency, because the system uses the modular framework with the service-orientation communication module, which is decisive in distributed and heterogeneous environments;
Enlarged flexibility and consistent reconfigurability, which is required by distributed control systems.

1-2. (canceled)

3. Method for the control of an automation and/or production system which presents software and/or hardware components, by means of a multi-agent system, where each software and/or hardware component is represented by a software agent, characterized in that each software agent interacts with the software and/or hardware component that it represents, and offers resources and functions of the latter in the form of a service-oriented software agent as individual services that can be called by other service-oriented software agents, and in that each service-oriented software agent, to achieve its own goals, calls services of other service-oriented software agents.

4. Multi-agent systems for the control of an automation and/or production system which comprises software and/or hardware components, where each software and/or hardware component is represented by a software agent,
characterized in that the software agents have a service-oriented design, where each a software agent presents means for service provision and means for service query, the service-oriented software agents present means for the interaction with the software/hardware component which is represented by these agents,
the resources and functions of the software/hardware component are acquired by the a service-oriented software agent, and offered as services for other service-oriented software agents, and
each service-oriented software agent presents means to achieve its individual goals by calling services provided by other service-oriented software agents.
